(19) United States
(12) Patent Application Publication
(10) Pub. No.: US 2002/0067905 A1
(43) Pub. Date: Jun. 6, 2002

(54) Electrochromic optical attenuator

(75) Inventors: Charles Douglas MacPherson, Ottawa (CA); Keith Anderson, Nepean (CA); Steven Paul McGarry, Carp (CA)

Correspondence Address: Thomas Adams & Assoc., P.O. Box 11100, Station H, Ottawa, ON, K2H 7T8, CA

(73) Assignee: NORTEL NETWORKS LIMITED

(21) Appl. No.: 09/726,409

(22) Filed: Dec. 1, 2000

(51) Int. Cl. G02F 1/15

(52) U.S. Cl. 385/140; 359/265

(57) ABSTRACT

An electrochromic variable optical attenuator having low insertion loss, and which is substantially insensitive to the polarization of optical signals transmitted therethrough, is disclosed. The attenuator includes an annular working electrode, and a counter electrode surrounding and spaced from the annular working electrode in a coplanar configuration. Also included is an electrochromic layer in peripheral contact with the annular working electrode; and a further electrochromic layer overlying the counter electrode. An electrolyte overlies and is in contact with the two electrochromic layers; so that upon application of an electrical voltage between the electrodes, the optical density of the electrochromic layer is altered, thereby varying the attenuation of incident optical signals transmitted therethrough.

The invention relates to variable optical attenuators.

### BACKGROUND OF THE INVENTION

Various electrochromic optical attenuators are known in the art. U.S. Pat. No. 4,245,883 entitled ELECTROCHROMIC OPTICAL DEVICE, issued Jan. 20, 1981 discloses an electrochromic optical attenuator for polarized light from a waveguide. In such a device, optical attenuation is achieved by using an electrochromic material, and a solid or liquid electrolyte sandwiched between a pair of electrodes.

When an electric field of a particular polarity is present between the electrodes, ions and electrons from the electrolyte and one electrode, respectively, migrate into the electrochromic material. This results in a change from a clear to colored state of the electrochromic material, thereby increasing its optical density, which results in absorption of the electromagnetic light energy travelling along the waveguide. When the electric field is removed, little movement of the ions results and the attenuation remains relatively stable.

However, when the electric field is reversed, the ions and electrons migrate in the opposite direction and the electrochromic material clears, thereby reducing the absorption and hence the optical attenuation of the device. Thus, optical attenuation is controlled by varying the magnitude and polarity of the electric field applied between the electrodes.

Another example of an optical attenuator for polarized light is disclosed in an article entitled “An Electrochromic Variable Optical Attenuator (ECVOA)” by Nada A. O'Brien et al., Optical Fiber Conference, PD26-1 to PD26-3; San Diego, Calif., Feb. 21-26, 1999.

Still another example of an optical attenuator is disclosed in German Patent No. DE3528285 entitled “Arrangement for defined adjustable attenuation of an optical transmission path with an electrically controllable optical attenuator” published 1987-02-19 and invented by Giehmann Lutz. The disclosed configurations of the attenuators include two electrodes disposed on separate substrates on opposite sides of the electrolyte, thereby requiring critical alignment during assembly. This adds both cost and complexity to the finished product.

Electrochromic materials have also been used for optical displays, such as watches. U.S. Pat. No. 4,443,115 entitled ELECTRONIC TIMEPIECE WITH ELECTROCHROMIC DISPLAY issued Apr. 17, 1984 illustrates a typical one of these devices.

An electrochromic light-modulating device having working and counter electrodes disposed laterally, is described in U.S. Pat. No. 5,760,945 entitled DEVICE AND METHOD FOR LIGHT MODULATION issued Jun. 2, 1998. Here, however, instead of using an electrochromic layer, metal ions in the electrolyte are deposited on the transparent working electrode by electrocrystallization, thereby increasing the optical density of the interface region. By controlling the amount and direction of the current as well as the length of time over which the current is applied, the device may be rendered both optically translucent and opaque so that the desired fraction of the light is transmitted therethrough.

When utilizing electrochromic variable optical attenuators in many optical transmission systems such as telecommunication systems, it is advantageous to minimize their insertion loss, while providing a wide dynamic range of optical attenuation over the wavelengths of light which they operate. It is also desirable in many applications, that the devices be insensitive to the polarization of the incident light. Such devices should also be economical to manufacture.

### SUMMARY OF THE INVENTION

The present invention seeks to achieve the objectives outlined above, and overcome the limitations of prior art attenuators.

According to the present invention, there is provided an optical attenuator comprising a transparent non-conductive substrate, having a conductive annular working electrode and a conductive counter electrode disposed on one side of the substrate in a coplanar configuration. The counter electrode surrounds and is spaced from the annular working electrode. The attenuator includes a first electrochromic layer in peripheral contact with the annular working electrode, and a second electrochromic layer overlying the counter electrode. In addition, there is an electrolyte overlying and in contact with the electrochromic layers.

The attenuator may also include, as required, a transparent non-conductive cover and a sealant, to contain the electrolyte. In a particular application, the electrochromic layers are partially crystallized so as to substantially increase the attenuation range of the optical attenuator over that which can be achieved when the layers are amorphous.

When an electric field of a selected polarity is applied between the electrodes, the optical density of each of the electrochromic layers is altered (one increasing while the other is decreasing) thereby varying the attenuation of optical signals transmitted through the first electrochromic layer within the annular working electrode.

The attenuator may also include a transparent conductive layer on the one side of the substrate in contact with the electrochromic layer and in peripheral contact with the annular working electrode. Although it can increase the minimum insertion loss of the attenuator, this conductive layer would be included when shorter reaction times to the electric fields are desired.

Preferably, the electrodes are both gold (Au), while the electrochromic layers consist substantially of tungsten trioxide (WO₃); the transparent conductive layer consists substantially of indium tin oxide (ITO); the electrolyte is liquid consisting essentially of lithium perchlorate (LiClO₄) in propylene carbonate; and the substrate and cover are both antireflective coated glass.

### BRIEF DESCRIPTION OF THE DRAWINGS

Example embodiments of the invention will now be described with reference to the accompanying drawings in which:

FIG. 1 is a plan view of an electrochromic optical attenuator in accordance with the present invention;

FIG. 2 is a cross section, viewed from the underside, along the line 2-2 of the attenuator illustrated in FIG. 1;

FIG. 3 is a plan view of an alternate form of the electrochromic optical attenuator illustrated in FIG. 1; and

FIG. 4 is a cross section, viewed from the underside, along the line 4-4 of the attenuator illustrated in FIG. 3.

### DESCRIPTION OF PREFERRED EMBODIMENTS

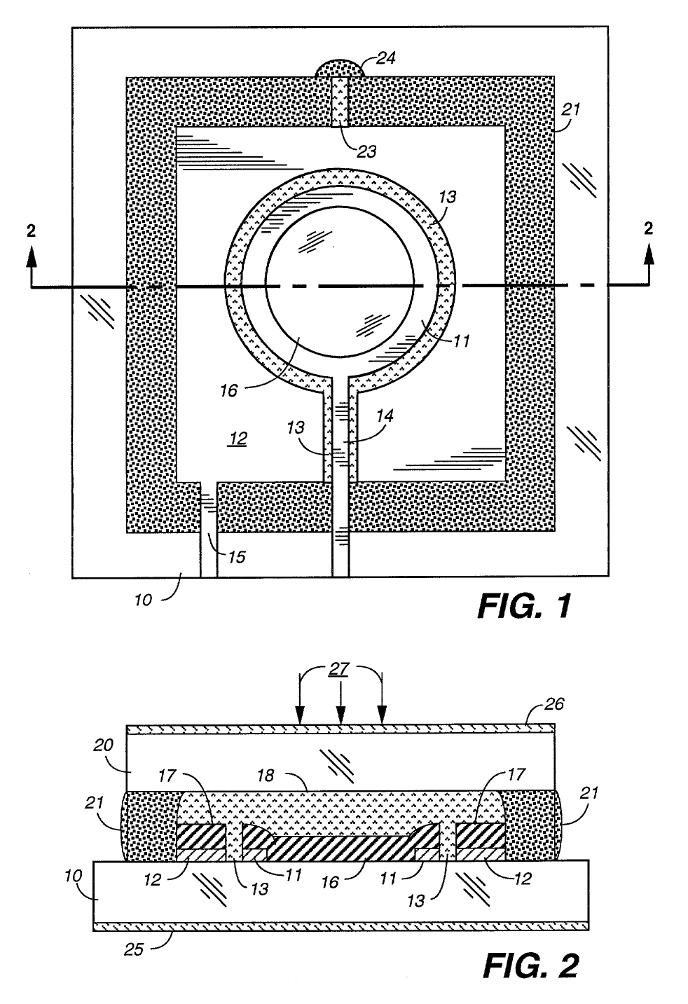

Referring to FIGS. 1 and 2, the electrochromic optical attenuator comprises a clear glass substrate 10 on which is disposed an annular working electrode 11, and a counter electrode 12, in a coplanar configuration, with the counter electrode 12 surrounding and spaced from the annular working electrode 11 by a gap 13. Extensions from the working electrode 11 and the counter electrode 12 provide terminals 14 and 15, respectively, for the application an electrical voltage. In the plan view of FIG. 1, the substrate 10 is viewed as transparent, in order to show the structure of the overlying elements described above.

The attenuator also includes a first layer 16 of tungsten trioxide (W03) on the substrate 10 in peripheral contact with the annular working electrode 11, and a second WO₃ layer 17 on the counter electrode 12. As well, there is a liquid electrolyte 18 of lithium perchlorate (LiClO₄) in propylene carbonate that is in contact with both the WO₃ layers 16 and 17. The electrolyte 18 is contained by a clear glass cover 20 and an epoxy sealant 21 which is disposed between the cover 20 and the substrate 10, and which surrounds the counter electrode 12.

Fabrication of the electrochromic optical attenuator commences with the clear glass substrate 10, on which the annular shaped working electrode 11, the counter electrode 12, and the terminals 14 and 15 are delineated in photoresist, using standard photolithographic techniques for metal liftoff. This is followed by vapour deposition of a layer of about 100-200 angstroms of titanium (Ti), then about 2000-3000 angstroms of gold (Au) over the substrate 10.

Following liftoff of the unwanted portions of Ti and Au, the attenuator is then patterned in photoresist for the first layer 16, and for the second layer 17, again using standard liftoff techniques. WO₃ is then deposited by reactive ion sputtering a tungsten target in an oxygen flow. To achieve up to 40 dB attenuation in the colored state, the depth of the deposited WO₃ is typically about 5000 angstroms. This is followed by liftoff of the unwanted areas of the WO₃ to form the layers 16 and 17.

To obtain the full 40 dB attenuation over an operating range of 1200-1800 nm (typically used in telecommunications), the WO₃ layers 16 and 17, which are initially amorphous, are annealed to a partially crystalline state by placing the semi-fabricated attenuator in an air or nitrogen atmosphere, at a temperature of about 380±25 degrees C. for about 10 minutes.

A preform of the epoxy sealant 21 containing 125-250 micron glass spacer beads is placed on the substrate 10, around the periphery of the counter electrode 12. After the clear glass cover 20 is fitted over and in contact with the sealant 21, the latter is cured. The sealant 21 forms the wall of a cavity, having a depth of about 125-250 microns. The cavity is injection filled with the liquid electrolyte 18, consisting of lithium perchlorate (LiClO₄) in propylene carbonate, through a small opening 23 (FIG. 1) in the sealant 21. To relieve thermal stress, a small gas bubble (not shown) may be left in the liquid electrolyte 18. Thereafter, an epoxy seal 24 is applied to close the opening 23.

The outer surfaces of the glass substrate 10 and the glass cover 20 include anti-reflection coatings 25 and 26, respectively, to further reduce, preferably minimize, the insertion loss of the attenuator. Typically, the annular electrode 11 has a diameter of about 1.5 mm, the width of the counter electrode is about 3.0 mm, while the gap 13 is about 0.2 mm wide. The surface area of the second WO₃ layer 17 is preferably at least the same as the surface area of the first WO₃ layer 16 so as to ensure charge balance during operation of the attenuator.

While metal such as gold is preferred for the electrodes 11 and 12, highly conductive materials such as indium tin oxide (ITO) may be substituted therefore. In addition, a gel or solid electrolyte may be substituted for the liquid electrolyte 18, although the latter generally provides the best operating characteristics. The coplanar design simplifies manufacturing since the working and counter electrodes 11 and 12 are both formed by a single process step during fabrication of the attenuator. This applies to the fabrication of the electrochromic layers 16 and 17 as well, which both consist of WO₃ and can also be deposited in a single process step. In addition, precise alignment of the glass cover 20 is not required.

As shown, incident light 27 is directed through the glass cover 20 in line with the first electrochromic layer 16. When an electric field is present between the electrodes 11 and 12 by the application of a negative voltage (of between 1-2 volts) to the terminal 14 relative to the terminal 15, lithium cations migrate from the electrolyte 18 into the layer 16 in the vicinity of the annular electrode 11. The result is that the area of the electrochromic layer 16 adjacent the electrode 11, which is initially an insulator, becomes conductive, thereby allowing electrons from the annular electrode 11 to flow into this area of the electrochromic layer 16 as well.

The electrochromic layer 16, originally colorless, commences to tungsten bronze (i.e. turn blue), around the periphery of the layer 16. As the peripheral area of the layer 16 turns conductive, the electric field broadens so that additional cations and electrons migrate towards the center of the layer 16. After a few seconds, the whole layer 16 becomes colored, resulting in an increase in its optical density, thereby attenuating the incident optical signals passing therethrough. The level of attenuation can be controlled by the magnitude and length of time the electric field is applied. By monitoring the optical throughput, an attenuation range from about 0.26 dB to 40 dB can be achieved and can be maintained by periodic reapplication of the field.

When the field between the electrodes 11 and 12 is reversed, by the application of a positive voltage to the terminal 14 relative to the terminal 15, the lithium cations migrate from the layer 16 to the layer 17 through the electrolyte 18, while anions from the electrolyte 18 flow towards the layer 16. This causes the layer 17 to color, while the layer 16 clears from the outside in towards its center, thereby reducing the attenuation of the optical signals passing through the attenuator.

Test results indicate the minimum insertion loss over the near infrared (NIR) operating range of 1310-1550 nm, is about 0.26 dB. Upon application of an electric field, the device achieves an attention of 20 dB in approximately 2 seconds and 30 dB in about 10 seconds. Because both coloration and clearing of the layer 16 proceed from the conductive working electrode 11 inwards, clearing of the layer 16 is much slower as its periphery returns to a non-conductive state, which then inhibits both ion and electron flow towards its center. The device was found to require about 10 to 15 minutes to recover about 80% of its transparency and up to 60 minutes for a full recovery. However, because the design is readily scalable, this slower response time may be reduced somewhat, by decreasing the diameter of the annular working electrode 11 to about 50-100 microns, and the gap 13 to about 50 microns.

One of the contributors to the minimum insertion loss of a NIR optical attenuator is the absorption/reflection losses due to presence of a transparent working electrode in the optical path. The absence of such an electrode in the optical path reduces the minimum insertion loss significantly. However, the trade off is that, without this transparent working electrode, the clearing process is significantly slower. In applications where higher operating speeds are required, and minimum insertion loss is not as critical, the coplanar design of the attenuator can be modified as follows.

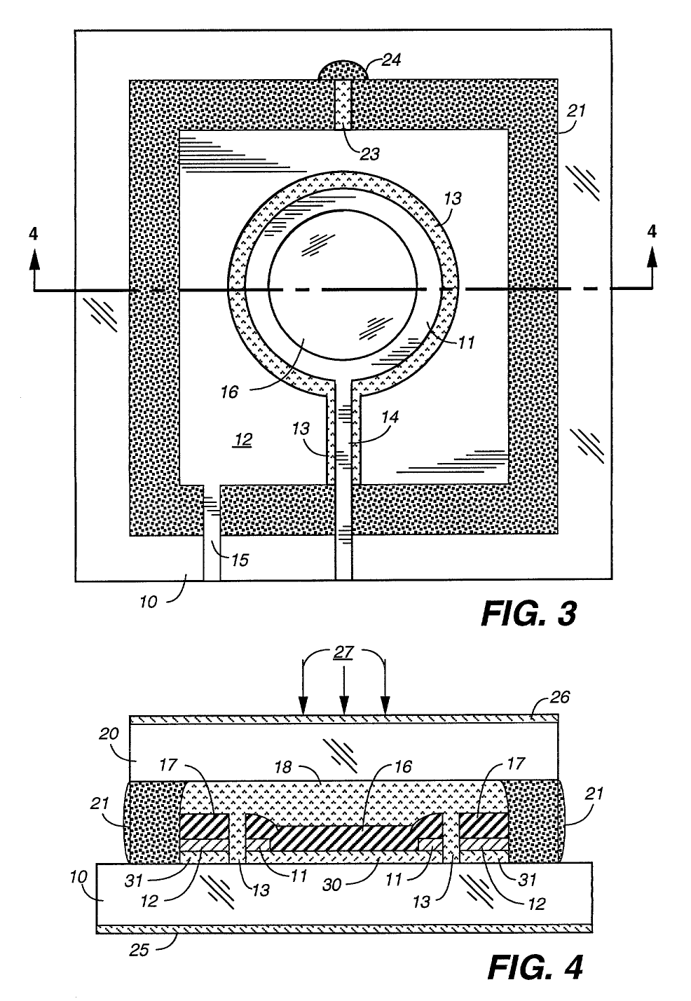

Referring to FIGS. 3 and 4, the structure and fabrication of the alternate attenuator is for the most part the same as that of the attenuator illustrated in FIGS. 1 and 2, except for the addition of an inner transparent electrode 30 and an outer transparent electrode 31 which together are disposed on the entire working area of the attenuator except in the area of the gap 13. The transparent electrodes 30 and 31 preferably consist of indium tin oxide (ITO) or alternately antimony tin oxide (ATO).

In the plan view of FIG. 3, the substrate 10 as well as the ITO electrodes 30 and 31 are viewed as transparent, in order to show the structure of the overlying elements described above.

Fabrication of this alternative attenuator commences with the clear glass substrate 10 having a layer of ITO with a resistivity of 10-100 ohms/sq. thereon. The working and counter electrodes 11 and 12 as well as the terminals 14 and 15 are fabricated as before but on the ITO layer rather than directly on the substrate 10. The device is then patterned by standard lithographic techniques for ITO removal in the gap 13 and beyond the periphery of the counter electrode 12. Wet etch of the ITO, using an acid solution (5% HNO₃ and 20% HCl at 50-60 degrees C.) is used to remove the unwanted ITO, leaving the two transparent ITO electrodes 30 and 31, the working and counter electrodes 11 and 12 and the terminals 14 and 15 on the substrate 10. The outer electrode 31 is not necessary for the operation of the attenuator but simplifies the fabrication of the device.

Fabrication of this alternative attenuator continues as described above, with the formation of the layers 16 and 17. It has been observed that, during the annealing step, which partially crystallizes the WO₃ layer 16, an interaction between it and the adjacent ITO layer 30 results in an approximate trebling of the resistivity of the layer 30. This also reduces the free carrier concentration in the ITO, consequently reducing optical absorption. Compensation for this change, if so desired, is readily achieved by starting with ITO having a resistivity suitably higher than the desired final value.

With a transparent ITO electrode 30 in the optical path having an initial resistivity of 10 ohms/sq (which increases to about 30 ohms/sq after annealing), the minimum insertion loss is increased to about 0.6 dB in the NIR operating range. The time required for the attenuator to reach an attention of 20 dB, upon application of an electric field, is similar to that of the device described with reference to FIGS. 1 and 2 without an ITO electrode, but the time for full recovery of transparency is reduced to about 60 seconds.

The contribution of the ITO electrode to the insertion loss of the attenuator device can be reduced by utilizing ITO with a relatively high sheet resistivity. For example 100 ohms/sq ITO (which increases to 300 ohms/sq after annealing) will produce an attenuator with an insertion loss of 0.5 dB or less. Also, the WO₃ layer thickness can be made such that a destructive interference effect (at a desired wavelength) minimizes the reflection of the WO₃ and therefore further reduces the insertion loss of the attenuator.

Finally, it should be noted that the attenuator design also lends itself well to constructing an array of the devices on a single substrate, each of which can be separately controlled. Such an array of devices could be readily utilized for channel power balancing in a wavelength division multiplexing (WDM) type system.

Electrochromic optical attenuators embodying features of the present invention advantageously may have a low insertion loss, a wide dynamic attenuation range, and are insensitive to the polarization of optical signals being attenuated thereby.

What is claimed is:

1. An electrochromic variable optical attenuator comprising:
a transparent non-conductive substrate;
a conductive annular working electrode on one side of the substrate;
a conductive counter electrode on said one side, surrounding and spaced from the annular working electrode;
the electrodes being substantially coplanar with each other;
a first electrochromic layer on said one side of the substrate, and in peripheral contact with said annular working electrode;
a second electrochromic layer overlying the counter electrode; and
an electrolyte overlying and in contact with the electrochromic layers;
whereupon application of an electrical voltage between the electrodes, the optical density of the first electrochromic layer is altered so as to vary the attenuation of incident optical signals transmitted therethrough.

2. An electrochromic variable optical attenuator as claimed in claim 1, wherein:
the conductive layer is partially crystallized so as to increase the attenuation range of the optical attenuator.

3. An electrochromic variable optical attenuator as claimed in claim 2, wherein:
the electrolyte is a liquid electrolyte; and
the attenuator further includes:
a transparent non-conductive cover;
and sealing means disposed between the transparent cover and the transparent substrate to contain the liquid electrolyte.

4. An electrochromic variable optical attenuator as claimed in claim 3, wherein:
the electrodes consist substantially of gold;
the electrochromic layers consist substantially of tungsten trioxide;
the liquid electrolyte is substantially lithium perchlorate, in propylene carbonate; and
the substrate and cover are clear glass.

5. An electrochromic variable optical attenuator as claimed in claim 1, further comprising:
a transparent conductive layer consisting substantially of indium tin oxide, disposed on the substrate in contact with the first electrochromic layer, and in peripheral contact with the annular working electrode.

6. An electrochromic variable optical attenuator comprising:
a working electrode and a counter electrode;
a first electrochromic layer;
a second electrochromic layer; and
an electrolytic layer;
wherein the working electrode is annular, the counter electrode surrounds and is spaced from the annular working electrode; and the electrodes are substantially coplanar;
the first electrochromic layer is in peripheral contact with the annular working electrode;
the second electrochromic layer is over the counter electrode;
the electrolytic layer overlies and is in contact with the first and second electrochromic layers; and
upon application of an electrical voltage between the electrodes, the optical density of the first electrochromic layer is altered so as to vary the attenuation of incident optical signals transmitted therethrough.
